(19) United States
(12) Patent Application Publication
(10) Pub. No.: US 2011/0157472 A1
(43) Pub. Date: Jun. 30, 2011

(54) METHOD OF SIMULTANEOUSLY WATCHING A PROGRAM AND A REAL-TIME SIGN LANGUAGE INTERPRETATION OF THE PROGRAM

(76) Inventor: Jukka Antero Keskinen, Helsinki (FI)

(21) Appl. No.: 13/044,577

(22) Filed: Mar. 10, 2011

Related U.S. Application Data
(63) Continuation-in-part of application No. 11/571,225, filed on Dec. 20, 2007.

(30) Foreign Application Priority Data
Jun. 24, 2004 (FI) PCT/FI2004/000389

(51) Int. Cl. H04N 5/445

(52) U.S. Cl. 348/564; 348/E03.001

(57) ABSTRACT

The invention is concerned with a method for facilitating the watching of films, TV programs and the like, meant for deaf people and people with hearing damage. The method allows a transparent or translucent shadow graph to be produced on the screen.

### PRIOR APPLICATIONS

This is a continuation-in-part patent application that claims priority from U.S. patent application Ser. No. 11/571,225, filed 20 Dec. 2007 that claims priority from PCT/FI2004/000389, filed 24 Jun. 2004.

### BACKGROUND AND SUMMARY OF THE INVENTION

It is often difficult for a deaf or hearing impaired viewer to enjoy regular programs and films etc. that are broadcast on TV, computer screens and other digital or analogical media. The prior art methods uses a sign window or a box shown on the picture in which another person interprets the dialog of what is happening on the screen by displaying gestures of a sign language in the window/box. One drawback of this is that the window covers a part of the whole picture and therefore while the deaf viewer is observing the signs the viewer cannot fully concentrate of what is shown on the screen because the signs must be followed constantly since it is not like reading subtitle text. The deaf viewer cannot simultaneously watch the separate side-window/box that shows the sign language interpretation while watching the main screen. In other words, it is important to realize that the sign language of the gesturing hand and/or facial expression must be constantly followed when reading it as opposed to reading conventional subtitled text where the reader can often easily and simultaneously read the text and view the moving pictures. This is partly because the text remains on the screen for a while. In contrast, the signs of the sign language continuously change along with the changes of the moving pictures. There is a need for an improved way of assisting deaf or hearing impaired viewers to enjoy programs etc. shown on digital screens such as televisions or computers. The present invention provides an important solution to this problem.

An important feature of the present invention is that the deaf or hearing impaired viewer can, while simultaneously viewing the sign language, fully concentrate on what is shown on the picture screen i.e. the movie or other program.

The method of the present invention facilitates the watching of TV programs, DVD and Blue-Ray films and the like, meant for deaf people and people with hearing impairment.

Thus, the present invention is concerned with the presentation of gestures of sign language in different analogical and digital environments, such as television, video, DVD, and with special equipment at movie theaters.

Gestures of sign language are the native language of deaf children and children with hearing damage, and before these children learn how to read, they need programs that are presented in sign language. The society is obliged to produce these programs. The sign language is also the mother tongue of the deaf and they have a right to have TV-programs etc. in their mother tongue.

The presently used method is the so called sign window. It is a box shown on the picture, in which a person interprets the dialogue or what is happening on the show to the viewer with gestures of sign language. The drawbacks of this method are that:

a) the window effectively covers part of the whole picture screen and
b) while the viewer is observing the signs, he/she can not fully simultaneously concentrate on what is shown in the movie or other program.

Unlike with subtitles, where it is possible for the viewer to learn how to read multiple sentences simultaneously, a person has to follow the sings constantly.

The object of the present invention is to achieve an improvement on the presently known method and avoid the drawbacks of the present method.

The present invention cleverly uses so called lap dissolve technology in a new, surprising way.

A shadow graph, of for example signing hands, is set on (or behind) the picture. The interpretation in sign language can also be facial expressions, or signing hands together with facial expressions. The gestures are transparent, so they do not cover any part of the picture area. The viewer sees the picture and the signs on top of each other and can read the sings without having to concentrate fully on them.

A sign can have the size of the whole screen or it can be smaller depending on the situation. It can be removed from faces for example. Subtitling in sign language can be used in all digital picture formats. The signs are stored in an appropriate place in digital form and can be used both in analogical and digital environments.

The invention is explained more thoroughly by referring to one advantageous embodiment of the invention presented in the figures in the enclosed drawing, although the invention is not meant to be limited to only this embodiment.

### BRIEF DESCRIPTION OF THE DRAWINGS

FIG. 1 presents the program shown on the screen accompanied with a transparent shadow graph of the sign language interpretation; and

FIG. 2 presents a semi-transparent upper body including face and hands disposed over an on-going program shown on a TV or computer screen.

### DETAILED DESCRIPTION

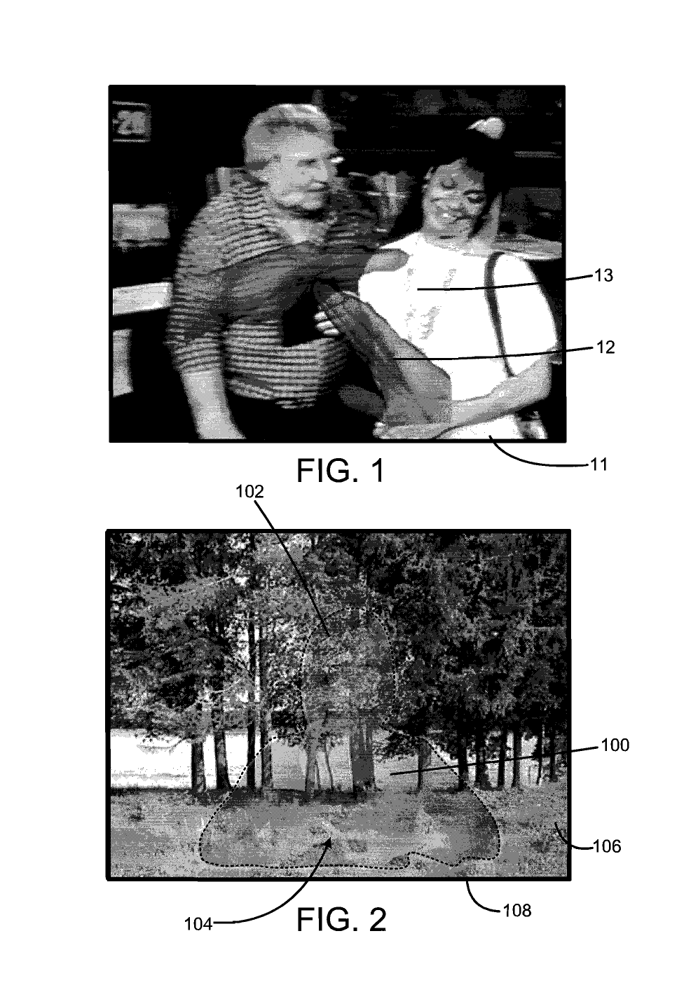

In the embodiment of the invention according to FIG. 1, the program shown on the screen, which can be a TV program, a dvd program, movie or the like, is marked with reference number 11. The digitally stored sign language interpretation is marked with reference number 12. From FIG. 1 it can be seen how a deaf person or a person with hearing damage observes the TV program 11 accompanied with the sign language interpretation 12 as TV program 13 interpreted according to the invention.

What is described above is only the principle of the invention and some of its applications. It is obvious for one skilled in the art that the details of the invention may vary significantly within the scope of the inventive idea presented in the enclosed claims.

FIG. 2 is an illustrative example of a front-view of a semi-transparent upper body including face and hands disposed over an on-going program shown on a TV or computer screen. More particularly, the semi-transparent body 100 has a face 102 and hands 104 that moves to provide a simultaneous sign language interpretation of what is said on the on-going program 106 shown on the TV or computer screen 108 behind the body 100. The body 100 has been provided with dashed lines to make it easier to see the contours of the body 100. However, it is to be understood that normally no dashed lines are used in the present invention when displayed on the screen in reality.

In operation, the method of the present invention is for facilitating the watching of programs shown on the screen for deaf people and people with hearing impairments. More particularly, the digital picture screen 108 is provided that shows the program 106. A real-time sign language interpretation is produced by a sign language interpreter with the combinations of the transparent or semi-transparent hands 104, and/or face 102 and body 100 expressions interpreting the program 106 shown on the digital picture screen 108. This may be done by displaying gestures of the transparent hand and/or facial expression and/or body gestures on top of or over the program 106 shown or broadcast on the digital picture screen 108. An important feature of the present invention is that the program displayed behind the transparent or semi-transparent hand and/or facial and/or expression and/or body gestures is visible through the transparent hand and/or facial expression and/or body gestures. There is thus no need for a separate side-window or box in one of the corners of the screen. In this way, a viewer can simultaneously watch the gestures of the transparent hand or facial expression interpreting the program 106 simultaneously in real-time and the program itself displayed on the digital picture screen without having to also watch a separate window on the digital picture screen. The size of the over-laying display is preferably about the same size as the entire TV or computer screen 108. The exact size of the sign language interpretation is changeable. Preferably, the sign language interpretation is formed by movable hands, facial expressions separately or hands together with facial expressions, and in need also with body gestures. The method is thus called “shadow signing” and the end product or the result may be “shadow sign” or a “ghost sign” etc.

In other words, the passive viewer may watch a regular program on TV and transparent or semi-transparent hands or facial expression i.e. “shadow sign” are simultaneously displayed across the entire TV screen in real-time. Preferably, the sign language interpretation of the program is provided to the deaf viewer so that the deaf viewer can enjoy the program as well as or at least almost as well as a person with normal hearing would. Because “shadow sings” or the transparent hand or facial expression interpret what is going on in the program, the deaf viewer can simultaneously watch both the program and the transparent sign language interpretation. The “shadow sign” may not be completely transparent or translucent but should be sufficiently semi-transparent so that the viewer can see what happens on the screen behind the moving hand. The “shadow sign” could also be completely transparent except for the outlines or the contours of the hand or facial expression or body gestures so that the deaf viewer can see what signs or information are being displayed by the “shadow sign”.

While the present invention has been described in accordance with preferred compositions and embodiments, it is to be understood that certain substitutions and alterations may be made thereto without departing from the spirit and scope of the following claims.

1. A method for watching programs shown on a digital screen, comprising:
providing a digital picture screen showing a program;
producing a sign language interpretation with a transparent hand and/or facial expression and/or body gestures interpreting the program shown on the digital picture screen with gestures in real-time; and
displaying the gestures on top of the program;
a viewer simultaneously watching the gestures of different combinations of the transparent hand or body or facial expression interpreting the program and the program displayed on the digital picture screen without watching a separate window on the digital picture screen.

2. The method according to claim 1, wherein a size of the sign language interpretation is changeable.

3. The method according to claim 1 wherein the sign language interpretation is moved on the digital picture screen.

4. The method according to claim 1 wherein the sign language interpretation is formed of signing hands, facial expressions and body gestures separately or with different combinations.

5. The method according to claim 1 wherein the sign language interpretation is stored in a digital form.
